(19) United States
(12) Patent Application Publication
(10) Pub. No.: US 2002/0169147 A1
(43) Pub. Date: Nov. 14, 2002

(54) Compositions for controlling pests

(76) Inventors: Peter Hertlein, Leichlingen (DE); Gunther Nentwig, Leverkusen (DE); Elke Reifenberger, Sankt Augustin (DE); Hermann Neumann, Haan (DE); Ernst Schuller, Leverkusen (DE); Karl-Heinz Lupkes, Leverkusen (DE)

Correspondence Address: Richard S. Bullitt, Bayer Corporation, 36 Columbia Road, Mirristown, NJ, 07962-1910, US

(21) Appl. No.: 10/040,816

(22) Filed: Jan. 7, 2002

(30) Foreign Application Priority Data
Jan. 17, 2001 (DE) 10101771.5

(51) Int. Cl. A01N 65/00; A01N 37/34

(52) U.S. Cl. 514/65; 514/519

(57) ABSTRACT

Novel active substance combinations exhibit an improved action against pests and allergens.

The invention relates to compositions for controlling pests.

The control of arthropods, especially of mites and cockroaches, which are present both in private households and in public buildings, for example in hospitals, but are also present as ectoparasites on domestic animals and livestock, is of great significance from the standpoint of hygiene. Since such organisms also release allergens, which in severe cases may trigger allergies such as rhinitis or asthma, there is a need for measures to control arthropods and allergens.

Arthropods, especially ticks, mites and cockroaches, have to date been controlled by deploying formulated active arthropodicidal substances, examples being pyrethrins and pyrethroids (K. Chisaka et al., Jap. J. San. Zool, 36 (1), 7-14 (1985)) or, in the case of mites, by means of substances such as benzyl benzoate (A. F. Kalpaklioglu et al., Allergy 51 (3), 164-170 (1996)), for example. References have also already been made to the insecticidal action of organic acids, such as octanoic acid, for example, and alcohols, such as diethylene glycol monoethyl ether, propylene glycol, benzyl alcohol or octanol, for example (WO 89/12673, EP-A 173 229, DE-A 30 27 144).

Allergens are generally controlled by denaturing them. The use of tannic acid, for example, has been disclosed.

The invention provides combinations of components selected from at least two, preferably from three, of the following groups a, b and c:

a) (i) pyrethrin, pyrethroids;

(ii) aromatics from the group consisting of benzenes, benzaldehydes, benzoic acids and derivatives thereof, preferably benzoic esters such as benzyl benzoates,

(iii) phenols, phenol alcohols, phenyol aldehydes, phenol acids and derivatives thereof (such as salts or esters), preferably o-phenylphenol and its salts such as o-phenylphenol sodium;

b) (i) surfactants, preferably anionic surfactants, such as sodium lauryl sulphate, for example, and/or

(ii) polyacrylates;

c) (i) monohydric and/or polyhydric aliphatic, cycloaliphatic or araliphatic alcohols, such as ethanol, isopropanol, benzyl alcohol, for example, and/or

(ii) aliphatic carboxylic acids having preferably from 8 to 18 carbon atoms.

By combinations in the sense of the invention are meant not only embodiments comprising all of the components and combination packs containing the components separately from one another, but also components applied simultaneously or at different times, provided that they serve to control pests and/or allergens produced by them.

Preferred pyrethroids a) embrace the following active substances:

1) 3-allyl-2-methylcyclopent-2-en-4-one- 1-yl d/l-cis/trans-chrysanthemate (allethrin/Pynamin®),

2) 3-allyl-2-methylcyclopent-2-en4-one-1-yl d-cis/trans-chrysanthemate (Pynamin forte®),

3) 3-allyl-2-methylcyclopent-2-en-4-one-1-yl d-trans-chrysanthemate (Bioallethrin®),

4) 2,3,5,6-Tetrafluorobenzyl (+)-1R-trans-2,2-dimethyl-3-(2,2-dichlorovinyl)-cyclopropanecarboxylate (transfluthrin, Bayothrin®),

5) (S)-3-propargyl-2-methyl-cyclopent-2-en4-one-1-yl (lR)-cis/trans-chrysanthemate (prallethrin/Etoc®),

6) 3-phenoxybenzyl (IR)-cis,trans-2,2-dimethyl-3-(2-methylprop- 1-enyl)cyclopropanecarboxylate (phenothrin)

or mixtures of these active substances.

Particular preference is given to using the active substances 3-allyl-2-methylcyclopent-2-en4-one-1-yl d-trans-chrysanthemate (Bioallethrin®),

3-phenoxybenzyl (I R)-cis,trans-2,2-dimethyl-3-(2-methylprop- 1-enyl)cyclopropanecarboxylate (phenothrin) and

2,3,5,6-tetrafluorobenzyl (+)-1R-trans-2,2-dimethyl-3-(2,2-dichlorovinyl)-cyclopropanecarboxylate (transfluthrin),

Preferred surfactants b) (i) include anionic, cationic and nonionic compounds, such as are described, for example, in “Methoden der Organischen Chemie” (Houben-Weyl), vol. 14/1, Georg Thieme Verlag, Stuttgart 1961, pp. 192-208. Preferred surfactants b) include nonionic and anionic emulsifiers such as polyoxyethylene fatty acid esters, polyoxyethylene fatty alcohol ethers, e.g. alkylaryl polyglycol ethers, alkylsulphonates, alkyl sulphates, arylsulphonates and protein hydrolysates.

Preferred polyacrylates b) (ii) include optionally crosslinked acrylic acid homopolymers and copolymers and their salts, as are described, for example, in WO 92/1377. The polyacrylates b) (ii) are preferably water-soluble or water-dispersible. In general they possess a molecular weights of from 2000 to 5,000,000, preferably from 100,000 to 3,000,000. Preferred comonomers for the copolymers b) (ii) include methacrylic acid, alkyl acrylates and alkyl methacrylates, and N,N-dialkylacrylamides. Ethylene, vinyl acetate, styrene and vinyl chloride are also suitable comonomers. The amount of comonomer units in the copolymer b) (ii) is generally less than 50, preferably less than 30% by weight, based on the copolymer.

Crosslinking comonomers may be used as well—they serve primarily to modify the molecular weight.

Preferred crosslinked polyacrylates b) (ii) are carbomers, i.e. copolymers of acrylic acid with bifunctional and/or polyfunctional monomers, such as are sold, for example, by the company B.F. Goodrich under the brand name ®Carbopol and are described, for example, in WO 96/3038. Preferred bifinctional and/or polyfunctional monomers include divinyl glycol, allylsucrose and allylpentaerythritol. The molecular weights of the carbomers are estimated at up to 4,000,000,000; however, such high molecular weights are no longer measurable. The viscosities of these carbomers are generally from 100 to 10,000 cP, measured as a 0.02 to 2% strength by weight neutralized dispersion in water using a Brookfield viscometer (20 revolutions per minute) at 25° C.

Preferred bases for preparing the salts b) (ii) include ammonium and alkali metal (preferably sodium and potassium) hydroxides, carbonates and hydrogen carbonates (e.g. sodium hydroxide, sodium carbonate, sodium hydrogen carbonate) and amines, preferably C₁-C₆-alkylamines and hydroxy-C₁-C₆-alkylamines such as triethylamine and triethanolamine.

The molecular weights stated above for the polyacrylates b) (ii) are in each case the molecular weights determined as weight averages.

The combinations of the invention, which may be used undiluted or, preferably, diluted, may be employed in the formulations customary for arthropodicides, in other words as aerosols, foams, powders, emulsions, suspensions and solutions.

The formulations may be prepared conventionally, for example by mixing the active substances with auxiliaries and/or extenders, i.e. liquid solvents and/or solid carrier materials, optionally with the use of surface-active agents. Where the extenders used comprise water, organic solvents, for example, may also be used as auxiliary solvents. Suitable liquid solvents include substantially: aliphatic hydrocarbons such as cyclohexane or paraffins, e.g. petroleum fractions, alcohols such as ethanol, n-propanol, isopropanol, ketones such as acetone, and water.

As solid carrier materials, mention may be made of the following: e.g. natural ground minerals such as kaolins, aluminas, talc, chalk, quartz, attapulgite, montmorillonite or diatomaceous earth and synthetic ground minerals such as highly disperse silica, aluminium oxide and silicates. Suitable solid carrier materials for granules include e.g. crushed and fractionated natural minerals such as calcite, marble, pumice, sepiolite, dolomite, and also synthetic granules of organic and inorganic flours and also granules of organic material such as, for example, sawdust, coconut husks, maize cobs and tobacco stalks.

In the formulations it is possible to use adhesives, such as carboxymethylcellulose, for example, natural and synthetic polymers in powder, particle or latex form, such as gum arabic, polyvinyl alcohol, polyvinyl acetate, for example, and also natural phospholipids such as cephalins and lecithins, for example, and synthetic phospholipids.

Mineral and vegetable oils, for example, are further possible additives.

The combinations of the invention generally comprise

| | |
|---|---|
| from 0.01 to 10 | parts by weight of a) (i) to (ii) and/or |
| from 0.01 to 5 | parts by weight of a) (iii), |
| from 0.01 to 10 | parts by weight of b) and |
| from 1 to 90 | parts by weight of c). |

The formulations generally comprise from 0.01 to 50% by weight, preferably from 0.05 to 30% by weight, in particular from 0.1 to 10% by weight of the combination of the invention.

The combinations of the invention may be used successfully to kill harmful or nuisance arthropods, especially arachnids, and at the same time to denature allergens.

The arachnids include mites (e.g. Sarcoptes scabiei, Dermatophagoides sp., Dermanyssus gallinae, Acarus siro) and ticks (e.g. Ixodes ricinus, Argas reflexus, Omithodorus moubata, Boophilus microplus, Amblyomma hebraeum, Rhipicephalus sanguineus).

The combinations of the invention are preferably employed to counter arachnids of the order Acari, and with very particular preference to counter the suborder Sarcoptiformes, particularly to counter house dust mites (Dermatophagoides pteronyssinus, Dernatophagoides farinae, Euroglyphus mayneri).

Among the allergens, mention may be made preferably of those of the house dust mites (Der pl and Der fl).

The following examples for the formulations and for the use of the combinations of the invention serve to further illustrate the invention. Percentages are in each case by weight. Parts are parts by weight; ratios are weight ratios.

### EXAMPLES

Formulation example 1

Composition in the form of pump spray for spray application to substrates, comprising 5 parts benzyl benzoate, 0.2 part o-phenylphenol, 2 parts sodium lauryl sulphate, 5 parts 1,2-propylene glycol, 45 parts isopropanol, and water to 100 parts.

Formulation example 2

Composition in the form of an aerosol for spray application to substrates, comprising 3 parts benzyl benzoate, 0.1 part o-phenylphenol, 1 part sodium lauryl sulphate, 5 parts 1,2-propylene glycol, 35 parts isopropanol, 0.3 part ®Tween 80, water to 100 parts, and 10 parts propane/butane.

Biological activity

The following biological examples demonstrate the efficacy of the compositions of the invention:

1. Efficacy against mites

Method:

A mixed population of the species Dermatophagoides pteronyssinus is used.

The upper rim of a plastic dish (Ø 7 cm, height 3 cm) is provided with glue and then covered with a piece of ticking of the same diameter. A spatula-tip full from a culture dish containing mites and feed (ground Tetramin) is placed on the ticking.

The dish is then placed on an inverted Petri dish in a plastic container (33×22 cm, height 6.5 cm), containing saturated sodium chloride solution, and the container is closed with a lid.

The next day, 0.4 ml of the composition of the invention is applied to the material.

The set-up is illuminated by daylight, the temperature is 24-26° C., and the relative atmospheric humidity within the closed plastic container is approximately 75%.

After 2 hours, 1, 3, and 7 days the state of the mites in comparison with a control treated only with isopropanol/water (1:1) is rated under a stereomicroscope (3=numerous mites, 0=no mites). Direct counting is impossible since dead animals are difficult to see.

If required (control, ineffective products), more feed is added.

Three experimental units are set up for each experiment, and after the end of the experiment the sum of the scores is recorded.

Results:

TABLE 1

| | |
|---|---|
| Experiments according to the invention | |
| 5.0% Benzyl benzoate | |
| 0.1% o-Phenylphenol | |
| 1.0% Na lauryl sulphate | 1.5 |
| 5.0% Propylene glycol | |
| 5.0% Benzyl benzoate | |
| 0.1% o-Phenylphenol | 1.5 |
| 1.0% Na lauryl sulphate | |
| 5.0% Benzyl benzoate | |
| 1.0% Na lauryl sulphate | 2.5 |
| 5.0% Propylene glycol | |
| 5.0% Benzyl benzoate | |
| 0.1% o-Phenylphenol | 2.5 |
| 5.0% Propylene glycol | |
| 5.0% Benzyl benzoate | 6.0 |
| 5.0% Propylene glycol | |
| 5.0% Benzyl benzoate | 6.0 |
| 0.1% o-Phenylphenol | |
| Comparison: individual components | |
| 5.0% Benzyl benzoate | 9.0 |
| 5.0% Propylene glycol | 9.0 |
| 1.0% Na lauryl sulphate | 9.0 |
| 0.1% o-Phenylphenol | 9.0 |
| Control | 9.0 |
| (isopropanol/water = 50:50) | |

0 = no mites, 9 = numerous mites (estimated per evaluation)

2. Efficacy against allergens

Method:

A 500 mg dust sample of known allergen content (DER P1) is distributed uniformly over aluminium foil (0.25 m²).

The surface is then sprayed with the composition of the invention having the following composition: 5.0% benzyl benzoate+0.1% o-phenylphenol+1.0% Na lauryl sulphate +5.0% propylene glycol.

After 1, 3 and 7 days, the allergen content is determined by means of ELISA.

Results:

TABLE 2

% Allergen content after

| Application rate | | 1 d | 3 d | 7 d |
|---|---|---|---|---|
| | Control | 100 | 100 | 100 |
| | 7.5 g | 60 | 43 | 27 |
| | 15.0 g | 20 | 18 | 11 |

As the application rate and incubation time increase, the allergen content goes down.

1. Combinations of components selected from at least two of the following groups a, b and c:
a) (i) pyrethrin, pyrethroids;
(ii) aromatics from the group consisting of benzenes, benzene aldehydes, benzene acids and derivatives thereof,
(iii) phenols, phenol alcohols, phenyol aldehydes, phenol acids and derivatives thereof;
b) (i) surfactants and/or
(ii) polyacrylates;
c) (i) monohydric and/or polyhydric aliphatic, cycloaliphatic or araliphatic alcohols and/or
(ii) aliphatic carboxylic acids.

2. Combinations according to claim 1, where group a) comprises transfluthrin, benzyl benzoate, o-phenylphenol and its salts.

3. Combinations according to claim 1, where group b) comprises sodium lauryl sulphate.

4. Combinations according to claim 1, where group c) comprises ethanol, isopropanol, propylene glycol, benzyl alcohol, carboxylic acids having from 8 to 16 carbon atoms and mixtures thereof.

5. Combinations according to claim 1, where the components are selected from the following groups:
a) transfluthrin, benzyl benzoate, o-phenylphenol, o-phenylphenol sodium;
b) surfactants; polyacrylates;
c) ethanol, propylene glycol, isopropanol, benzyl alcohol, carboxylic acids having from 8 to 16 carbon atoms.

6. Method of controlling pests and/or allergens, where combinations according to claims 1 to 5 are caused to act on the pests and/or on the allergens or are deployed in their habitat.
